(19) United States
(12) Patent Application Publication
(10) Pub. No.: US 2016/0134746 A1
(43) Pub. Date: May 12, 2016

(54) METHOD AND APPARATUS FOR CONTEXT BASED USER INTERFACE PRESENTATION

(71) Applicants: Bernard P. TOMSA, West Bloomfield, MI (US); Michael C. VARTANIAN, Commerce Township, MI (US)

(72) Inventors: Bernard P. TOMSA, West Bloomfield, MI (US); Michael C. VARTANIAN, Commerce Township, MI (US)

(21) Appl. No.: 14/938,366

(22) Filed: Nov. 11, 2015

Related U.S. Application Data
(60) Provisional application No. 62/078,964, filed on Nov. 12, 2014.

(51) Int. Cl. H04M 1/725; H04W 4/00; H04W 4/02

(52) U.S. Cl. CPC H04M 1/72586; H04W 4/023; H04W 4/008

(57) ABSTRACT

Through use of the illustrative embodiments, users can have device-related applications presented at the appropriate times when the user is proximate to a given device, in communication with the device, and will likely want to use an application related to the device. Since the user can configure the menu, undesired applications can be relegated to lower levels of importance when display space is limited, and when devices cannot communicate with a user mobile device, other context can be utilized to determine which applications to load. Other context can also be used whenever desired in lieu of communicating with devices, to determine the presentation and ordering of applications on a mobile device, so a user can benefit from these concepts even if communication with local devices or applications unrelated to local devices are desired. Efficient and appropriate usage of limited display space can be automatically obtained, so that a user is never too many clicks or scrolls away from a relevant application for a given situation based on that user's preferences.

### CROSS REFERENCE TO RELATED APPLICATIONS

This application claims the benefit of U.S. Provisional Application Ser. No. 62/078,964, filed Nov. 12, 2014, the disclosure of which is hereby incorporated in its entirety by reference herein.

### TECHNICAL FIELD

The illustrative embodiments generally relate to a method and apparatus for context based user interface presentation.

### BACKGROUND

There are literally thousands of portable devices that exist in the market today, and hundreds of thousands of applications that can be run on these devices. It is not uncommon for a user to download twenty or thirty applications to be installed on a portable device, ranging in use from shopping list applications, to games, to television control applications. The scope of applications is virtually limitless, and countless new applications are being developed and made available monthly.

On a portable device such as a tablet or a smart phone, the number of applications can quickly become overwhelming. A user can be forced to switch between multiple screens to view all the applications available, and, unless frequently used applications are ordered in some manner, a visual search must be performed whenever an application is desired.

Newer portable devices, such as smart glasses and smart watches have recently been announced and/or come onto the market place. Of course, with an item such as a smart watch, the display is significantly smaller than a typical smart phone, and the comparison is even worse compared to a tablet. Interaction with applications on such devices often requires frequent scrolling to obtain the appropriate application.

### SUMMARY

In a first illustrative embodiment, a system includes a processor configured to present a selectable application-identifying graphic, usable for launching an application related to a controllable device proximate to a mobile device, on a mobile device display, the presentation based at least in part on the mobile device being within a predetermined proximity to the controllable device.

In a second illustrative embodiment, a system includes a processor configured to launch an application, related to a controllable device, on a mobile device, the launch based at least in part on the mobile device being within a predetermined proximity to the controllable device.

In a third illustrative embodiment, a system includes a processor configured to present a selectable application-identifying graphic, usable for launching an application related to a controllable device, on a mobile device display, the presentation based at least in part on the mobile device having received a wireless device-identifying signal from the controllable device.

In a fourth illustrative embodiment, a system includes a processor configured to launch an application, related to a controllable device, on a mobile device, the launch based at least in part on the mobile device having received a wireless device-identifying signal from the controllable device.

### BRIEF DESCRIPTION OF THE DRAWINGS

FIG. 1 shows an illustrative home layout, with multiple points of context;

FIG. 2 shows an illustrative process for application presentation;

FIG. 3 shows an illustrative process for application configuration;

FIG. 4 shows an illustrative process for application launch, display or configuration;

FIG. 5 shows an illustrative process for application setup;

FIG. 6 shows illustrative sample mobile device displays;

FIG. 7 shows an illustrative configuration process based on multiple context inputs;

FIG. 8 shows an illustrative example of a method for “automatically” selecting an application based on context;

FIG. 9 shows an illustrative example of an application ordering process; and

FIG. 10 shows an illustrative example of a further application ordering process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Mobile devices, such as smartphones, have displays that are limited in the visual capacity to display information, such as selectable icons. While it is possibly irritating for a user to scroll through multiple screens of icons to select a pertinent application icon, this irritation will only be exacerbated through a reduction in screen size. On a mobile device such as a smart watch, significantly fewer icons (possibly only one) or other application identifiers will be displayed on a per/screen basis, and thus increased scrolling will be needed. If a user installs several hundred applications, finding an application for use in a given scenario will potentially take valuable time each time an application is needed.

While many applications have use in varied scenarios, it is also true that a user may frequently use the same application in a same location or scenario over and over again. For example, with respect to an application that allows control of a television, this application may frequently be used when in proximity to the television, but less frequently used when out of viewable range of the television (unless functions such as setting a digital recording are present).

Or, for example, a restaurant recommendation application may commonly be used around meal times, or maybe on Friday nights, but will less commonly be used at three in the afternoon. Through observing context related to application usage, it is possible to predict usage of a particular application in a given context, and to provide that application for a user when the context occurs.

One good way to determine context is through the identification of physical devices that may be present, specifically devices that may be controllable through the application. Other common context variables include, but are not limited to, weather, time of day, day of week, location, etc. By providing applications in an on-demand fashion based on observed behavior under context, users can experience a much more intuitive utilization of devices with limited display space. Of course, other presentation of application choices, voice, etc. is also possible utilizing the illustrative embodiments. For example, without limitation, the illustrative embodiments could present a number of applications for utilization audibly and seek verbal confirmation of one or more applications to present on a display or launch.

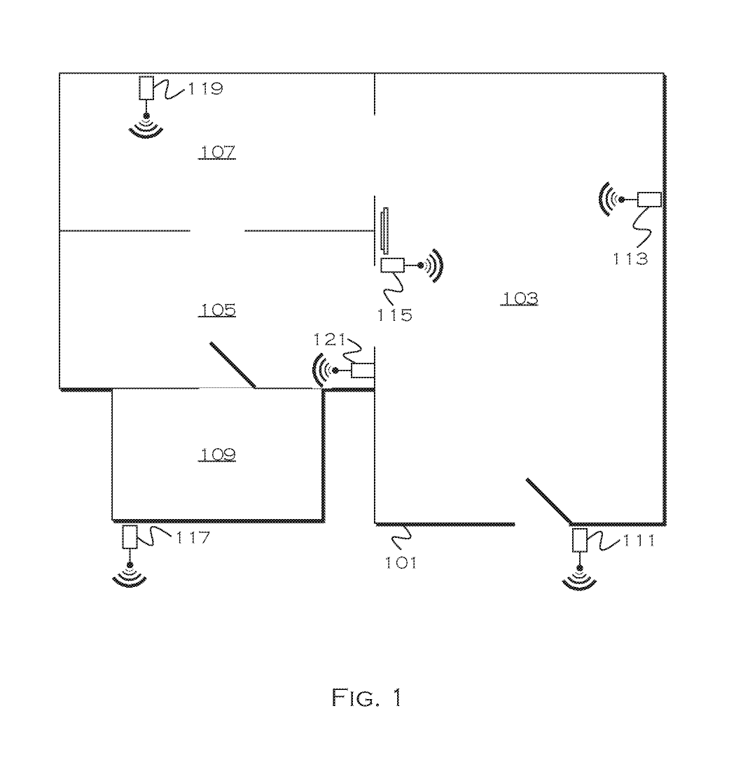

FIG. 1 shows an illustrative home layout, with multiple points of context. In the illustrative example shown in FIG. 1, a first floor of a home 101 has a living room 103, a dining room 105 a kitchen 107 and a garage 109. In the living room is a door entry system 111, a thermostat 113, and a television 115. In the dining room is a wall outlet or a light switch 121, in the kitchen is a radio 119 and the garage has a door opening control 117. Each of these devices is provided with a local information broadcast device, such as, but not limited to, a BLUETOOTH beacon. In each instance, the beacon broadcasts an identifier identifying the beacon and which can be used to determine the device the beacon is provided to (through a look-up, a user configuration, etc.). Other beacons on other devices could provide additional information relating to the proximity of devices to each other and to the user, the more “self aware” the beacon the more information that can be provided.

For example, with regards to the TV, thermostat and radio, the beacons may be provided as part of the device itself (which could include providing beacon functionality to the device or including a beacon type transmitter/transceiver) and may identify (through, for example, identifiers in the signal or a lookup of the identification of the signal in the cloud) the device, a device manufacturer, etc. The beacons can also be used to determine proximity to the device, based on, for example, received signal strength. User location can be determined by various proximity to devices, and even if a home layout is not known precisely, it can still be determined which device a user is more proximate to based on signal strength or other appropriate factors. Also, application utilization can be determined based on proximity to certain devices, so the actual layout can be rendered irrelevant in certain situations.

For example, if a user is within 10 feet of the AM/FM radio, the user may utilize the radio application most frequently. On the other hand, if the user is within 10 feet of the radio and within 5 feet of the television, perhaps the television application is more frequently used. The thermostat application may be used regardless of exact user location, but may be used less frequently. The wireless outlet or light switch control 121 may be used when the user is within 7 feet of the wireless control 121 and within at least seventeen feet of the radio (essentially the overlapping space between a large radius around the radio and a smaller radius around the wireless control 121, signifying the user is present in the dining room). The door control application may typically be used to lock/unlock the door outside the house, so a proximity of five feet from the door and at least twenty five feet from the television may be the requisites for door control. A similar model may be used for garage door control 117.

Since the illustrative processes are capable of recording context (in this example, device proximity) when various applications are utilized, or at least when they are launched, a model for application usage based on location in the home can be developed. Once a model has been learned (or configured by a user), the processes can provide access to the most relevant application(s) when a user is in a given location or proximate to a given device. New devices broadcasting new identifying signals can be worked into existing models.

A simple configuration utility could have a user stand within 1 foot of a device, and all received signals could be measured, so a relative position of that device to other devices could be obtained, if desired. In other examples, the user can sit or stand in commonly used locations and select a particular application or application set to be accessed in that location, and thus a configuration for that location or similar locations could be established. Application presentation can also be prioritized based on usage so, for example, if only a single application can be presented at a time, the presentation can be made based in order of usage (i.e., the most commonly used application is presented, the secondary application(s) are set up to be close in access (e.g., one screen away) for that location. A standard ordering of applications can be saved and can revert once the context configured ordering ends (i.e., the user moves to an unrecognized location or an unrecognized context occurs).

A general configuration based on more generalized context may also be the “default” when at least some context information is known. For example, if a user only uses home-control applications before 8 AM and after 5 PM, these applications will be placed “far away” from the current application in a scrolling list or scrolling screen display, between the hours of 8 AM and 5 PM (possibly only on weekdays, for example). On the other hand, geographic parameters may be more useful or used in conjunction with time parameters (e.g., between 5 PM and 8 AM, if the user is within a predetermined geographic area (denoting the home), utilize certain applications).

Other configuration utilities could also be possible, for user's wishing to “fine tune” their systems, such as, for example “stand in the middle of X room and push OK.” Doing this for each room of the house would allow the processes to get a benchmark for which devices were in which proximities to the center of a room, and thus more easily determine which devices were located in a given room. In another illustrative example, the user could utilize a map or floor plan and “place” the beacons according to their respective positions, allowing the device to have some idea of relative beacon placement for each room. Maps including latitude and longitude within a building could also be utilized, and, for example, floor information could be determined by a mobile device utilizing a barometer.

On the other hand, some users may not want to deal with configuration utilities. Even for these users, the presence of one or more device-identifying beacons or broadcast signals could be used to determine proximity to a device, and the relative strength of the signal could be measured when applications are used to determine which applications are used when in proximity to which devices. If the devices don't provide signals, or for applications not related to devices, user locations, time of day, day of week, weather, etc. can be used to determine context for presenting a particular application or application set for use.

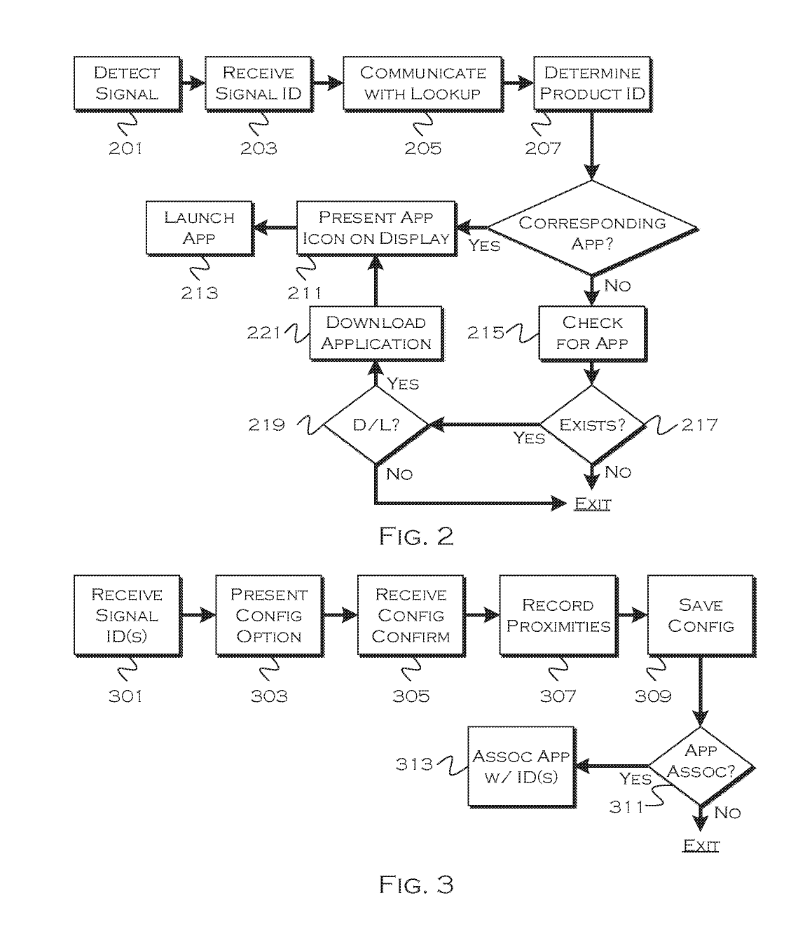

FIG. 2 shows an illustrative process for application presentation. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In many of the illustrative examples, a device providing a signal usable to identify the device will be used as a primary basis for context. It is to be understood that this is one useful application of the illustrative embodiments, but many of the illustrative embodiments (i.e., those not being device-specific) are useful even when such a device and/or signal is not present. More generally, any context within the home or any user environment can be used to determine which application(s) to present to a user.

In still another example, a user can configure what devices (if the devices cannot identify themselves) are present in a given room (i.e., at a given location) and associate any relevant applications with those devices. For example, if a user associates a video game application with “television,” then any room designated as having a television would have the application also associated therewith (because, for example, the user may wish to play the game during commercials).

The example shown in FIG. 2 relates specifically to devices providing identification and having a control application associated therewith. More generally, however, if the device could be identified through other means (such as, without limitation, location) and an application were manually associated with the specific device or a device type, the concepts in FIG. 2 could generally apply.

In this illustrative example, the process detects a signal being broadcast from a device. The signal identifies the device or a beacon within the device, and may be used to determine information about the device, including, for example, without limitation, a device controlling application, device related applications, device manufacturer, device serial number, device model, etc. Such signals from a TV having beacon functionality, for example, could be used by a proximate cable box to set the best settings for a given TV make and model. In other examples, even if the device cannot be identified through a signal, because, for example, no signal is present, the user could input any relevant information to be associated with the device and the presence of the device could be determined by user location.

In the example in FIG. 2, once the device signal has been received, the process, in this example, communicates with a cloud-based lookup to determine any relevant information about the device 207. If, for example, a manufacturer provides device information, the manufacturer may also provide the lookup information when the device-broadcast signal is received. While the signal may be referred to as device-broadcast, it is understood that the signal could come from a beacon or similar device provided as part of the main device and broadcasting the identifying signal.

In this example, the process also checks to see if a corresponding application (corresponding to the signal or other device identification) is present on the mobile device already 209. If the application is present, the process will present the application on a current display screen or other screen specified for application display, if the current screen cannot display applications, and/or will present an application configuration including at least the related application, if multiple applications can be shown and inclusion of the related application is appropriate (as will be discussed later) 211.

If the application is not currently present, the process will check 215 for the existence of such an application (e.g., a control application for the TV). This application could be located on a device memory and available for local download, be located on the cloud or on a manufacturer server. If the application exists for download 217, the process will offer to download the application 219. If the user agrees, the application is downloaded 221. Other uses could include download of, for example, an instruction or configuration manual, or other product relevant information. Once the application or information is downloaded, then in the future, when the signal is detected (or the device is otherwise identified as being relevantly proximate), the process can present the downloaded application/information for user use/consumption without being specifically requested to do so by the user. This creates a much more user friendly interface, especially if interface space is limited and applications must constantly be re-selected.

FIG. 3 shows an illustrative process for application configuration. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process allows a user to configure the display of information and/or an application related to a particular device. Again, once the signal identifying the device is received (or the device presence is otherwise identified), the process may initially (upon first use or upon user request) present a configuration option 303. This configuration option can allow the user to specify, for example, a priority or importance of the application. In another example, the user can associate previously unrelated applications with the device. For example, if a user wants to use a cable box (non-device related) control application and a video game application, when watching TV, the user might associate a cable box provider control application and the video game application with a signal from the television 303. Any applications can be associated with a given signal or other context, as desired.

Once the configuration has been confirmed 305, the process may record the current proximity to the device and to any other local device signals (to establish better proximal boundaries). While device proximity is certainly useful to determine when an application is presented, the proximity to other devices can help refine this process. For example, looking at FIG. 1, a ten foot radius around the television 115 extends into the kitchen and the dining room. If the user doesn't typically control the television from these rooms, display of the television related application(s) can be limited to time when the user is also within ten feet of the thermostat 113. Even though the thermostat is unrelated, its relative location to the television can be used to establish when a television related application is or is not launched.

Once any relevant proximities are recorded, or, in the case of a lack of device signals, when other relevant information such as current user GPS location has been recorded, the process can save the configuration 309. If any of the currently denoted applications are not already associated with any received device IDs 311, the process can associate those applications with the relevant ID(s) (which may be user designated) 313. The applications can be directly associated (i.e., the user specifies the association) or tangentially associated (the device is not user-associated, but its presence helps define when to launch/present the user specified applications).

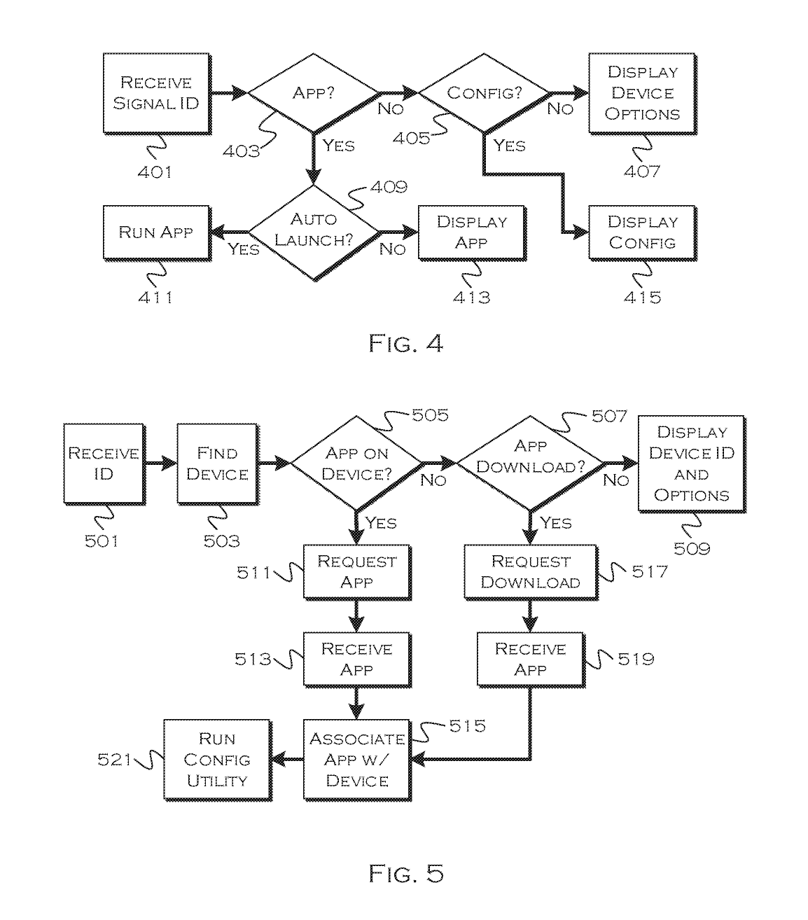

FIG. 4 shows an illustrative process for application launch, display or configuration. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process again receives a signal identifier from a device or identifies a device presence through use of context, as appropriate 401. If there is a related application(s) 403, the process will check to see if one of the applications should be automatically launched 409. This could be based on, for example, the frequency of usage far outweighing the other applications, or could be based on a user specification, for example. If any app is to be launched, the process will run the application 411, otherwise, the process will present the application(s) for user selection 413.

If no application(s) currently are associated with the device, the process will display an option to configure associations for that device 405. As previously noted, while the specific example is given with respect to a device, the process could be used more broadly. For any given context, the user could be given the option to configure one or more applications relating to that context, so that when the same context occurred, the process could launch the same application(s). If the configuration option 405 is confirmed, the process will display the configuration option 415. Alternatively, the process can display any other information relating to the device 407 that might be useful to the user, such as, but not limited to, device make/model/manufacturer or other possible actions that can be taken with respect to the device or device(s) detected or known to be present.

FIG. 5 shows an illustrative process for application setup. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process receives a device identifying signal or signal that can be used to identify the device 501, or otherwise identifies the location/proximity of a given device. The process finds the device 503 on a lookup table, provided at, for example, a generic information-clearing house type website (e.g., a TV site listing numerous makes and models of TVs) or on a manufacturer website, or in an app store, etc. Information relating to the device, obtained from one of the aforementioned sources, for example, may indicate that an application is available directly from the device (e.g., stored on a wirelessly or wiredly accessible local memory) or that an application may be downloaded for device control 507 or other interaction. Alternatively, remaining options 509 may be displayed, similar to those displayed at step 407.

If the application/information is available on the device itself, the process may request the application/information from the device 511. Once received 513, the process may associate the received application/information with the device 515, so that future detections of the device may result in presentation of the associated application/information. On the other hand, if the application/information needs to be downloaded, the process may request a download of the relevant information 517 and receive the application/information from the remote source 519. Once all appropriate associations have been made, the process may also run a configuration utility 521 allowing fine-tuning of the presentation criteria for the obtained information.

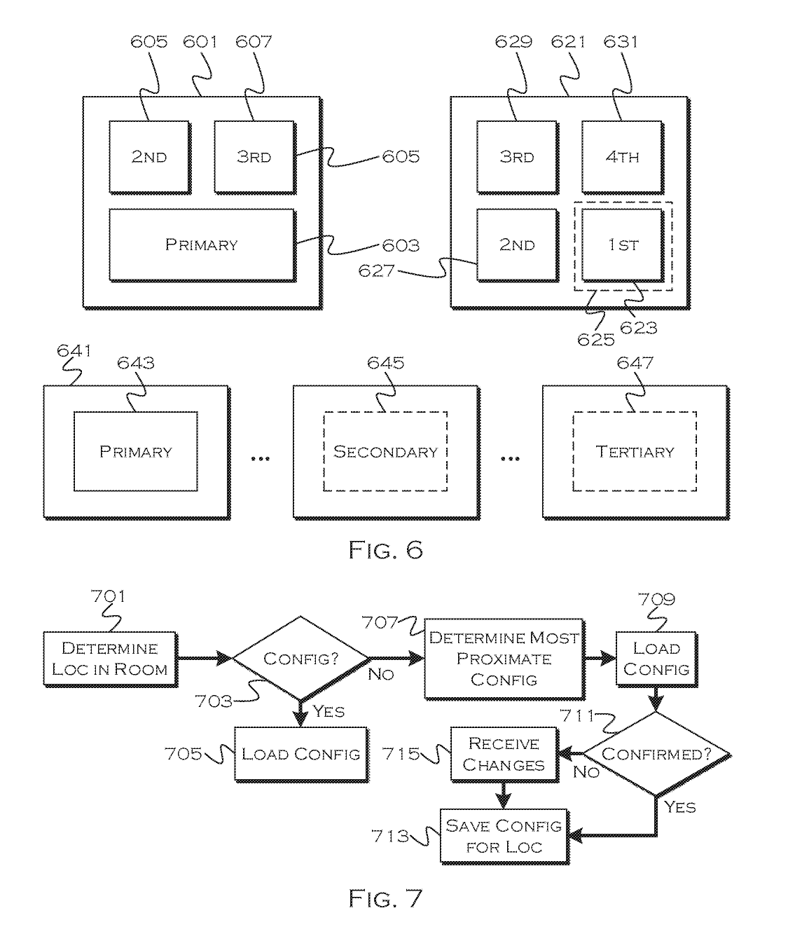

FIG. 6 shows illustrative sample mobile device displays. In this illustrative example, a plurality of varied application interface displays are shown, from which applications can be launched and information can be accessed. For example, in display 601, three applications are present. A primary application 603, a secondary application 605 and a tertiary application 607 are all present and may be selected and launched. Which application is considered primary, secondary, tertiary, etc. may be based on user designations, shifting context, frequency of use, etc. Display 621 is similar but has four applications provided thereto, and again the ordering and which applications are displayed can changed based on what devices are present or other shifts in context.

For example, while the user is in the living room 103, and more than ten feet from the door, the device may display a thermostat application in the fourth position 631, a TV control application in the primary position 623, a game in the second position 625 and a radio control application in the third position 629. Decisions on what applications to display can be based on a variety of factors, including, but not limited to, user specifications, proximity to devices, frequency of application usage, etc.

In the example above, the thermostat is displayed in position four in every room of the house, since the thermostat application gets used in any room of the house. The primary location 621 displays and highlights 623 the application relating to the closest device (or most frequently used of a plurality of close devices). The secondary position displays any secondary applications associated or commonly used in conjunction with the device (the game, in the earlier example) or an application relating to a secondary device in reasonable or detectable proximity). So too, with the third application position, which could, for example, be alternatively reserved for an internet browser or other generally commonly used application.

On the device 641, only a single application 643 can be displayed at a time. Instead of displaying multiple applications, the process orders the applications 645, 647 so that they are one-screen-away, two-screens-away, etc. This limits the amount of screen-scrolling the user must perform to access a secondary or tertiary application. The ordering of applications in any of these displays may shift with context, user location, user proximity to a device, etc. (which, technically, is all context). By presenting relevant applications based on device proximity, or, more generally, context, the user can have a display of relevant applications present when needed on a mobile device, without having to manually re-order a display or otherwise find and select the appropriate icons/applications. In at least one example, the primary application is decided based on a control application for control of the most proximate device or most frequently used control.

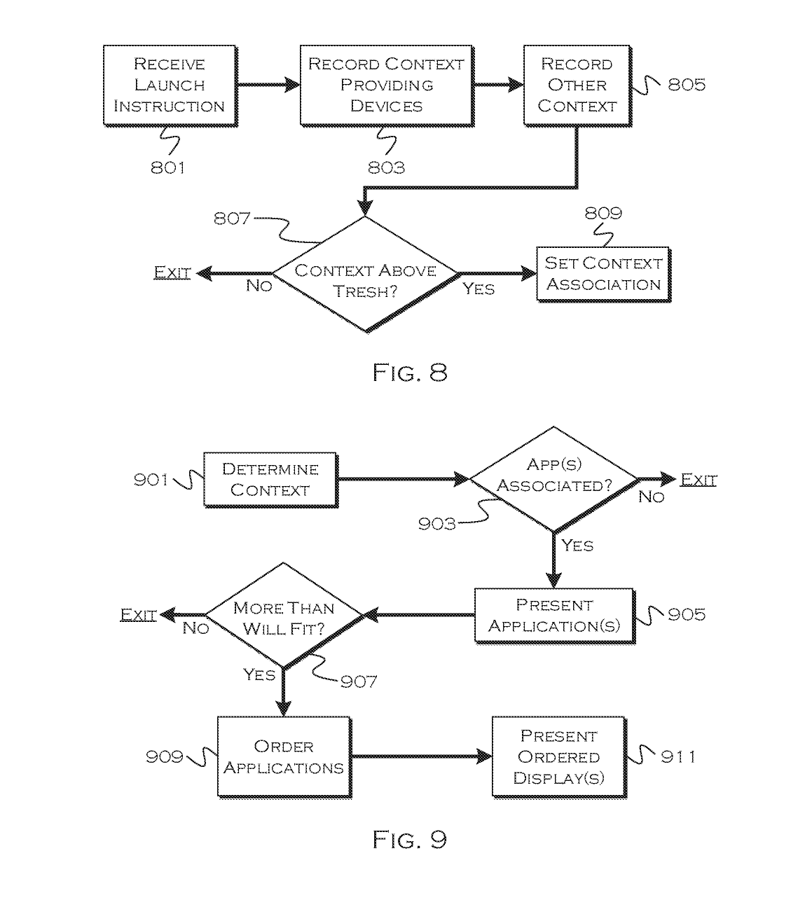

FIG. 7 shows an illustrative configuration process based on multiple context inputs. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, context is determined based on where a user is located within a room 701. For any given location, the process checks to see if there is a known configuration for that location 703. Some measure of tolerance may also be built into this check, so the user doesn't need exact configurations for every single room location, but could be within some reasonable distance (which can be room size dependent) of a previous configuration spot. Once a few configurations have been input for a few room locations, the process should be able to reasonably “guess” at the appropriate configuration for any location in the room.

If an appropriate configuration is present, the process will load the configuration 705. If an appropriate configuration is not yet known 703, the process will, in this example, determine the most proximate configuration to the current location 707 and load that configuration. Hopefully the most proximate configuration will be reasonably related to the desired configuration for that location, but the user can confirm this 711 and/or change the configuration 715 if the loaded configuration needs to be changed. The process can then save that configuration for the current location/context.

Location can be determined by a variety of factors, including GPS location, other mobile device coordinate systems, the presence of fixed or semi-fixed (e.g., TV) devices broadcasting signals, etc. Since, in at least one example, signal strength can be recorded to determine proximity to each device, location could be recorded as the signal strength of one or more signals. Signal strength based on a single signal generally specifies a perimeter (although, for example, passing into another room may diminish the strength and the perimeter may vary in distance for that signal strength. Signal strength based on multiple devices (triangulation or trilaterization, for example) will typically result in a more accurate specific location. Variances or tolerances in signal strength can also be utilized to denote regions surrounding a specified location.

FIG. 8 shows an illustrative example of another method for “automatically” selecting an application based on context. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this example, the process receives the instruction to execute an application 801 and the process records the presence of context providing devices (e.g., installed, local devices and/or beacons) when the application is launched. For example, if a user launched a web-browser while in the living room 103 of FIG. 1, the process would record the signals received from the television, thermostat and any of the other received signals. Any other relevant context (day, time, ambient light, GPS, weather, etc) may also be recorded if needed to determine context for presenting the launched application.

For each application or for at least one application on the device (the launched application in this example), the process will record instances of context relating to the current usage of the application, as well as previous usages of the application. When the context exceeds a measured threshold 807, then the application is associated with the context based on the common usage of the application in that context.

For example, if the internet browser is used more than threshold times in proximity to the television, then the browser application will be associated with the television (and thermostat and any other devices having a measured signal, in this example). The other contexts, if recorded, can also have an association to the application, so that a refinement of the overall context for application utilization can be determined over time. In at least one example, the context is limited to device and/or other beacon signals and the applications are thus related to the proximity to various devices.

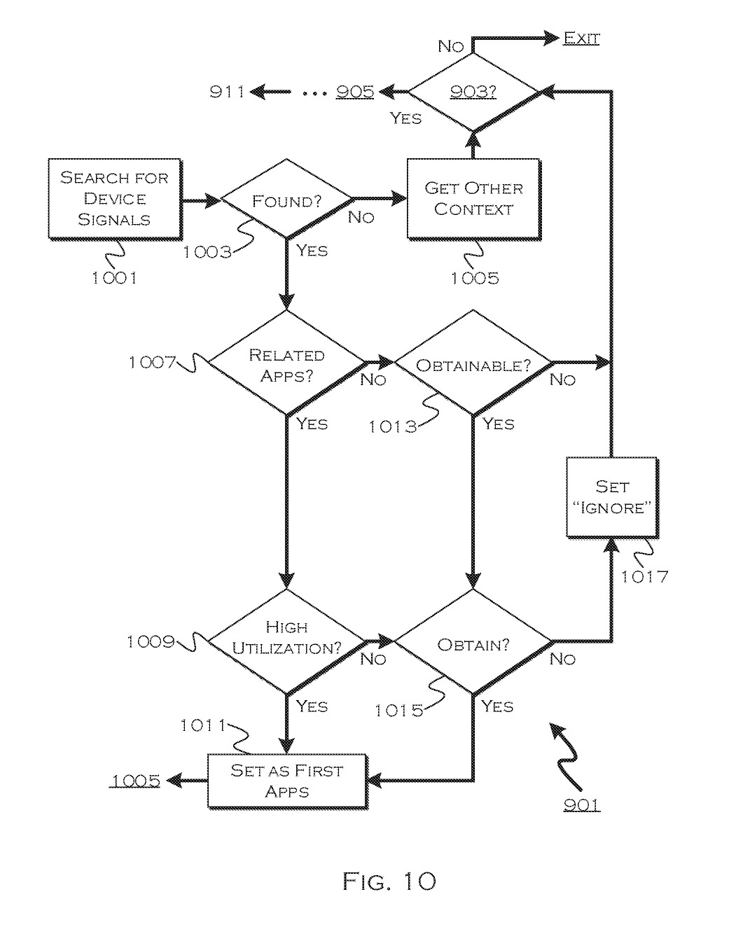

FIG. 9 shows an illustrative example of an application ordering process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process determines the context for a given situation, such as, but not limited to, detecting device beacon and other beacon signals (or using the other contexts discussed and suggested herein). If an application or applications have been previously associated with this context/signals 903, the process will present the applications 905 for utilization by the user. For example, a display including the relevant application(s) may be presented to the user when the context constraints are met.

If more applications than will fit on a single display are associated with the context 907, the process will order the applications according to an appropriate paradigm (further context beyond device presence can be used, frequency of use may play a factor, proximities to devices may be more carefully considered and more-proximate-device related applications may be given priority, etc) 909. The display or displays will then be presented in an ordered manner, so that the user is likely to have a desired application at (or close to at) their fingertips.

FIG. 10 shows an illustrative example of a further application ordering process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process searches for various device signals 1001 and, if found 1003, determines if there are applications related to the found device(s) 1007. For example, if the TV and thermostat signals were discovered, the process would determine if there were applications related to the TV and thermostat present on the device. If the application(s) are not found, the process determines if the applications are available 1013 (through previously discussed or similar methods) and, if so, asks if the applications should be obtained 1015.

If the applications are present, the process checks to see if utilization for these applications crosses a predetermined threshold (e.g., they were not just installed and forgotten) 1009, and, if so, the process gives priority to the device-related applications 1011 (for when displays are selectively ordered or display space is limited).

Once any device related applications have been assigned appropriate priority (other factors other than frequency of use can also be related to priority, it is not limited to that illustrative example), the process determines any other appropriate context 1005 and performs ordering based on applications related to the “other context,” eventually resulting in an ordered presentation of applications.

Also of note, in this example, if the user is offered an application once or a threshold number of times and the user declines to add the application, at some reasonable point an “ignore” flag is set 1017 so that the user is not continuously badgered about adding the application. Local record of the existence of the application can be stored, so the user can easily add the application through a configuration menu at a later time if the application is later desired.

Through use of the illustrative embodiments, users can have device-related applications presented at the appropriate times when the user is proximate to a given device, in communication with the device, and will likely want to use an application related to the device. Since the user can configure the menu, undesired applications can be relegated to lower levels of importance when display space is limited, and when devices cannot communicate with a user mobile device, other context can be utilized to determine which applications to load. Other context can also be used whenever desired in lieu of communicating with devices, to determine the presentation and ordering of applications on a mobile device, so a user can benefit from these concepts even if communication with local devices or applications unrelated to local devices are desired.

Through use of the illustrative embodiments, efficient and appropriate usage of limited display space can be automatically obtained, so that a user is never too many clicks or scrolls away from a relevant application for a given situation based on that user's preferences.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
present a selectable application-identifying graphic, usable for launching an application, related to a controllable device proximate to a mobile device, on a mobile device display, the presentation based at least in part on the mobile device being within a predetermined proximity to the controllable device.

2. The system of claim 1, wherein the processor is configured to change the display to include the selectable application-identifying graphic as part of presenting the selectable graphic.

3. The system of claim 1, wherein the processor is configured to visually change a standard form of the application identifying graphic to distinguish it from other application identifying graphics as part of presenting the selectable graphic.

4. The system of claim 3, wherein the visual change includes highlighting the application-identifying graphic.

5. The system of claim 3, wherein the visual change includes enlarging the application-identifying graphic.

6. The system of claim 1, wherein the predetermined proximity is determined based on a user-configured proximity.

7. The system of claim 1, wherein the predetermined proximity is determined based on a record of the application being used a threshold number of times within a distance representing the predetermined proximity.

8. The system of claim 1, wherein the processor is configured to determine which of a plurality of selectable application-identifying graphics, stored on the mobile device, to present, based at least in part on a relationship between a mobile device location and a controllable device location stored on the mobile device.

9. The system of claim 1, wherein the processor is further configured to present the application-identifying graphic based at least in part on the mobile device having received a wireless device-identifying signal from the controllable device.

10. The system of claim 1, wherein the application is a control application for controlling the controllable device.

11. A system comprising:
a processor configured to:
launch an application, related to a controllable device, on a mobile device, the launch based at least in part on the mobile device being within a predetermined proximity to the controllable device.

12. The system of claim 11, wherein the predetermined proximity is determined based on a user-configured proximity.

13. The system of claim 11, wherein the predetermined proximity is determined based on a record of the application being used a threshold number of times within a distance representing the predetermined proximity.

14. The system of claim 11, wherein the processor is configured to determine which of a plurality of applications, stored on the mobile device, to launch, based at least in part on a relationship between the controllable device, identified by a wireless-device identifying signal received from the controllable device, having a relationship to one of the plurality of applications.

15. The system of claim 11, wherein the processor is further configured to launch the application based at least in part on the mobile device having received a wireless device-identifying signal from the controllable device.

16. The system of claim 11, wherein the application is a control application for controlling the controllable device.

17. A system comprising:
a processor configured to:
present a selectable application-identifying graphic, usable for launching an application related to a controllable device, on a mobile device display, the presentation based at least in part on the mobile device having received a wireless device-identifying signal from the controllable device.

18. The system of claim 17, wherein the processor is configured to determine which of a plurality of selectable application identifying graphics, stored on the mobile device, to present, based at least in part on a relationship between the controllable device, identified by the wireless-device identifying signal, having a relationship to one of the plurality of applications.

19. A system comprising:
a processor configured to:
launch an application, related to a controllable device, on a mobile device, the launch based at least in part on the mobile device having received a wireless device-identifying signal from the controllable device.

20. The system of claim 19, wherein the processor is configured to determine which of a plurality of applications, stored on the mobile device, to launch, based at least in part on a relationship between the controllable device, identified by the wireless-device identifying signal, having a relationship to one of the plurality of applications.
